(19) United States
(12) Patent Application Publication
(10) Pub. No.: US 2016/0101641 A1
(43) Pub. Date: Apr. 14, 2016

(54) WRITING PAD

(71) Applicant: Donald Edward Gonzales, III, Homestead, FL (US)

(72) Inventor: Donald Edward Gonzales, III, Homestead, FL (US)

(21) Appl. No.: 14/878,639

(22) Filed: Oct. 8, 2015

Related U.S. Application Data
(60) Provisional application No. 62/061,255, filed on Oct. 8, 2014.

(51) Int. Cl. B42D 5/00; B43K 19/02; B42C 19/00; B32B 7/14; B32B 27/08; B32B 27/36; G09B 29/00; B32B 3/06

(52) U.S. Cl. CPC B42D 5/003; G09B 29/00; B43K 19/02; B32B 3/06; B32B 7/14; B32B 27/08; B32B 27/36; B42C 19/00; B32B 2250/244; B32B 2255/10; B32B 2307/73; B32B 2307/748; B32B 2554/00

(57) ABSTRACT

An article capable of use in writing is disclosed. The article comprising at least one sheet configured for being written onto with a writing device, wherein a material of the at least one sheet comprises each of polyester and taffeta.

### CROSS-REFERENCE TO RELATED APPLICATIONS

This application claims priority from a provisional patent application No. 62/061,255, filed on Oct. 8, 2014, which is incorporated herein by reference in its entirety.

### FIELD OF THE INVENTION

The present invention relates generally to a writing pad. More specifically, the invention relates to a writing pad with waterproof sheets.

### BACKGROUND

Commonly available writing pads suffer from numerous drawbacks such as their lack of ability to be utilized in wet environments. In addition, the paper is easily torn as a user uses the writing pad. Further, it is difficult to fold the writing pad so that it may be carried easily in a pocket.

Many people need writing pads while they are out of office and home. In such environments, the commonly available writing pads may not help people take notes in a secure fashion. For example, when people are out for fishing, camping, or they are engaged in other recreational and outdoor activities. Further, in general, writing pads contain plain sheets, which do not serve any other purpose than providing a surface for being written onto.

Commonly available waterproof notepads do not dry out when removed from the water and the pages stick together. Further, these waterproof notepads cannot be erased underwater. Special writing tools are necessary in order to write on the commonly available waterproof notepads.

Therefore, a new and improved writing pad is desired to provide more robust writing surfaces to users. The new and improved writing pad is designed to be stored in direct sunlight outdoors. The new and improved writing pad is designed to have pages that do not stick together and completely dries out back to original condition.

### SUMMARY

An article capable of use in writing is disclosed according to some embodiments. The article includes at least one sheet configured for being written onto with a writing device, wherein a material of the at least one sheet comprises each of polyester and taffeta.

A method of manufacturing an article capable of use in writing in a wet environment is disclosed according to some embodiments. The method includes forming a plurality of sheets of the article using a material comprising each of polyester and taffeta. The method further includes binding the plurality of sheets together to form a writing pad.

A writing pad capable of being used for writing in a wet environment is disclosed according to some embodiments. The writing pad includes a plurality of sheets made of a material comprising each of polyester and taffeta, wherein at least one edge of each of the plurality of sheets is secured together. The writing pad has the ability to be washed. Further, the writing pad is robust enough to withstand the roughest of conditions and can be used repeatedly.

### BRIEF DESCRIPTION OF DRAWINGS

FIG. 1 is a perspective view of an article capable of use in writing, in accordance with an embodiment.

FIG. 2 is a perspective view of one sheet of the article of FIG. 1, in accordance with some embodiments.

FIG. 3 is a perspective view of one sheet of the article of FIG. 1, in accordance with some embodiments.

FIG. 4A is a first perspective view of one sheet of the article of FIG. 1 being used to measure a length, in accordance with some embodiments.

FIG. 4B is a second perspective view of the sheet of the article of FIG. 1 being used to measure a length, in accordance with some embodiments.

FIG. 4C is a third perspective view of the sheet of the article of FIG. 1 being used to measure a length, in accordance with some embodiments.

FIG. 5 is a flowchart illustrating a method for manufacturing the article of FIG. 1, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

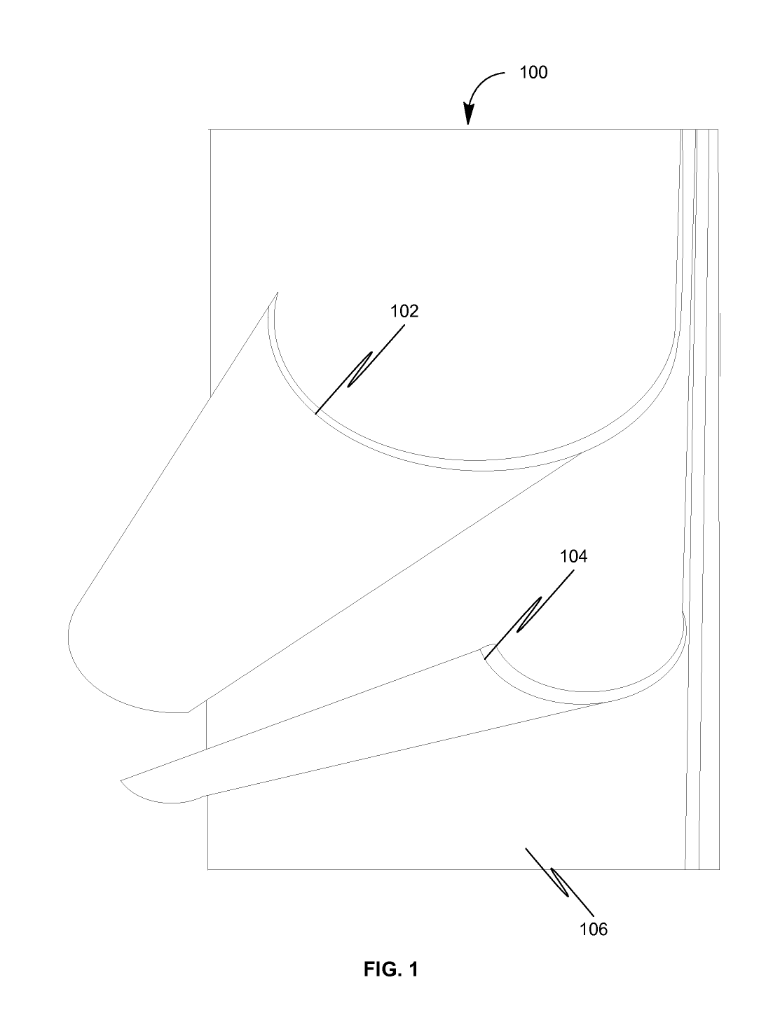

The present invention will be further illustrated with examples below. Referring to FIG. 1, a perspective view of an article 100 capable of use in writing is illustrated in accordance with an embodiment. The article 100 includes one or more sheets 102, 104 and 106. The one or more sheets 102, 104 and 106 are secured together to form a writing pad. For example, the one or more sheets 102, 104 and 106 may be secured together using releasable glue. Examples of glues that may be used include 356 MultiPro and 630 PeachPro from W. W. Henry Company located in Aliquippa, Pa. and other releasable glues.

Further, the one or more sheets 102, 104 and 106 are made using a material that comprises each of polyester and taffeta. For example, the one or more sheets 102, 104 and 106 may be made of a fabric woven using a thread made of polyester and taffeta. The material of the one or more sheets 102, 104 and 106 is a tear resistant fabric material. The material may be washed as well.

Moreover, the one or more sheets 102, 104 and 106 are water resistant and have a low moisture retention rating. The one or more sheets 102, 104 and 106 are capable of being written onto in a wet environment, wherein the wet environment comprises water. Although the one or more sheets 102, 104, 106 are capable of being written onto in a wet environment, the one or more sheets 102, 104, 106 are further capable of being written onto in a dry environment and further underwater or above water. For example, a lead pencil or an ink pen may be used to write on the one or more sheets 102, 104 and 106. The writing device used may be a pencil, namely a standard #2 pencil, pen, or any other writing instrument suitable for writing. When a pencil is used, the pencil writing may be erased. With any writing instrument, the writing on the one or more sheets 102, 104, 106 will not smear.

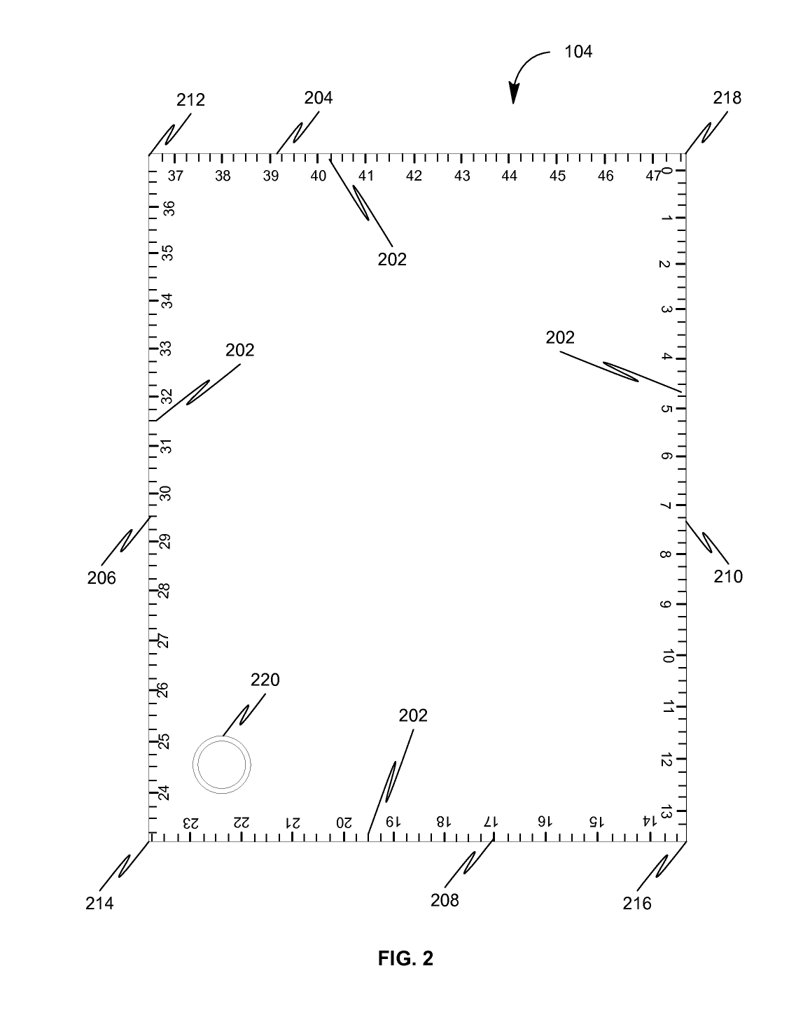

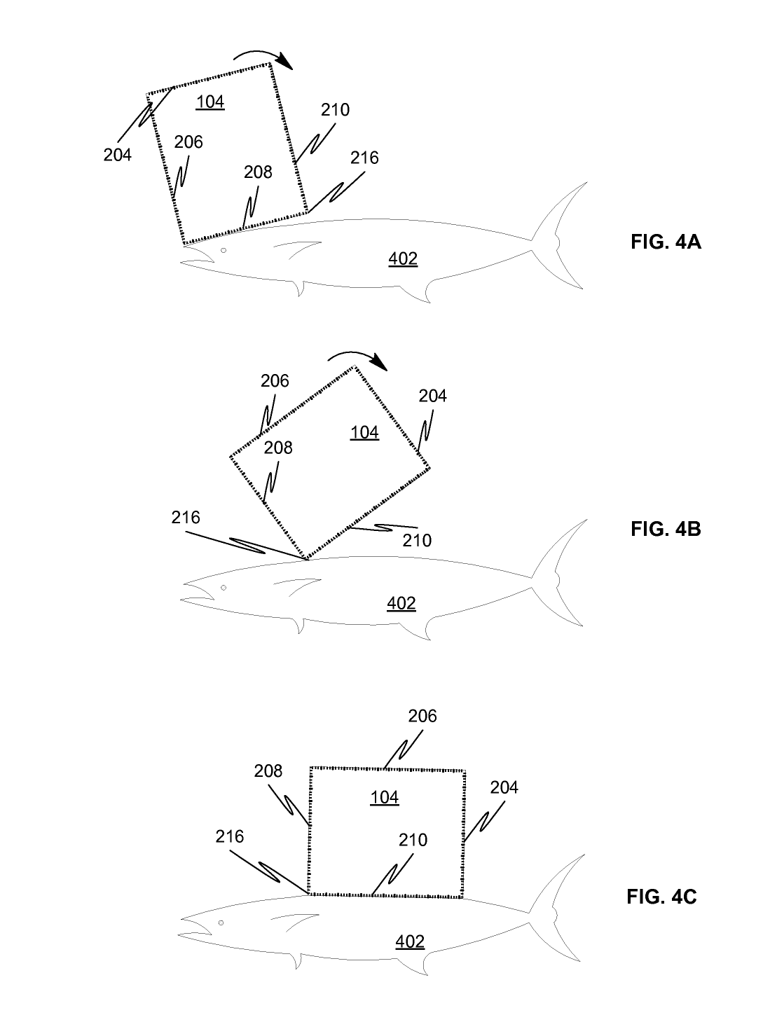

Now, referring to FIG. 2, the sheet 104 is illustrated in accordance with some embodiments. A portion of the sheet 104 includes printed information, which may include a plurality of equidistant markings 202 along two or more edges 204-210 on one or both surfaces of the sheet 104. The adjacent edges overlap each other at the four corners 212-218. The plurality of equidistant markings 202 may be numbered and the two or more edges 204-210 may be used as a ruler. This is explained in further detail in conjunction with FIG. 4 below. The sheet 104 may have any suitable dimensions, for example, the breadth may be 14 inches long and the length may be 48 inches long. Further, the printed information is indelible in a wet environment. The sheet 104 may also include a grommet 220 located at a peripheral region of the sheet 104. The grommet 220 located at a peripheral region of the sheet 104 may be used by a fastener to bind the one or more sheets 102, 104, 106. The fastener may be an aluminum fastener, specifically aluminum screw posts, or alternatively, an attachable clip or any other reasonable fastener used to fasten one or more sheets 102, 104, 106.

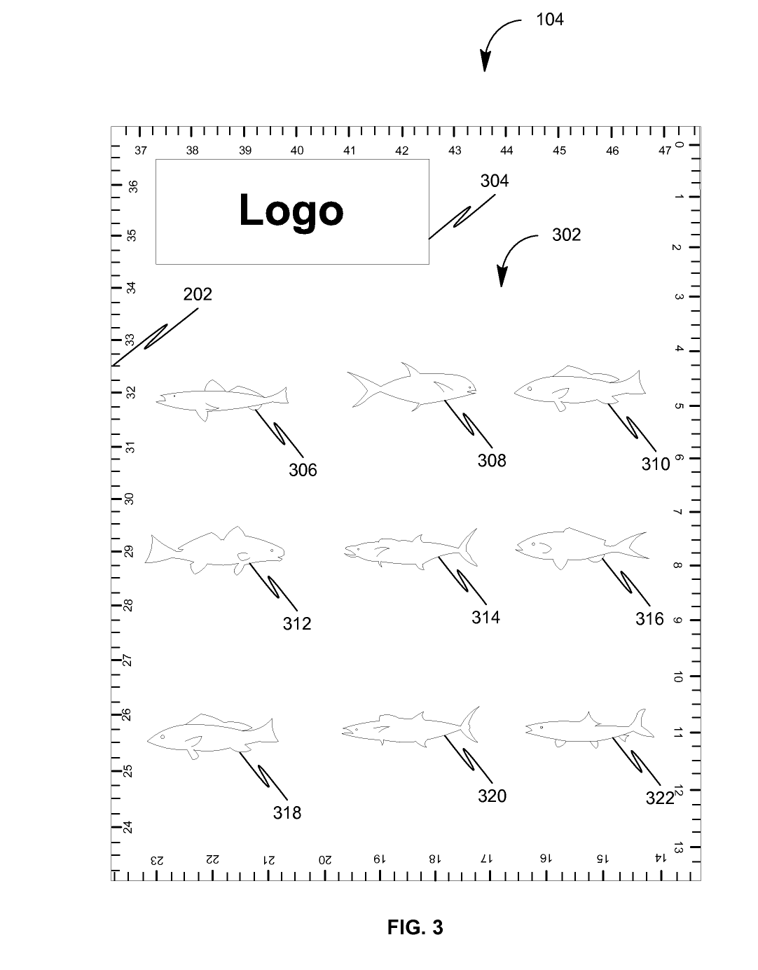

Further, the printed information on a portion of the sheet 104 may correspond to a guide such as a fishing guide, a hunting guide, a survival guide, a navigation guide, an animal guide, a plant guide, a bird guide, an insect guide and an aquatic guide. FIG. 3 is a perspective view of an exemplary fishing guide 302 that is printed on the sheet 104. Alternatively, the fishing guide may be printed on the cover sheet 102. The fishing guide 302 may also include the plurality of equidistant markings 202. The cover sheet 102 is made of scrim vinyl in the preferred embodiment but may be made of any other suitable material for a cover. The back of the cover sheet 102 or the back of present invention may be made of polystyrene in the preferred embodiment but may be made of any other suitable material for a backing.

The fishing guide 302 may include a space 304 for including branding information, such as placing the logo of the manufacturer. The fishing guide 302 helps people identify fish while they are fishing. There is a wide array of different fish found when people engage in fishing. While fishing, people like to know the species and the length of the fish caught by them. Accordingly, the fishing guide 302 may provide pictures 306-322 of various species of fish along with some information about each fish; for example, the name of the species, the normal size and weight of the fish. This information helps people identify fish they catch. However, the fishing conditions are often damp. The fishing guide 302 is made of a waterproof material; therefore, it is not damaged in damp conditions.

Further, the fishing guide 302 may be used to measure length of fish. This is explained in further detail in conjunction with FIG. 4 below.

Similarly many other types of guides may be printed on the sheet 104. For example, wild game identification guide; detailed hunting method guide, navigation guide, area maps of waterways, inlets, canals, lakes, rivers, streams, creeks, ponds; kayak and canoe trails and launch sites; area maps of hunting preserves; state parks and walking trails; bird identification guide; insect identification guide; reptile identification guide; aquatic or land mammal identification guide; lure spreads and recommended schematics for offshore fishing; scat identification guide; animal print identification chart; shark identification guide; archeology artifact identification; anthropology artifact identification guide; geology identification guide with or without pivot ruler; paleontology identification guide; botanical identification guide; plant species identification guide; survival guide; poisonous plants, animals, birds, reptiles, insects, flowers identification guide and educational recreational and outdoor activities.

Referring now to FIG. 4A, illustrating a first perspective view of the sheet 104 being used to measure length of a fish 402, in accordance with some embodiments. The edge 208 of the sheet 104 is placed along the body of the fish 402. Then, a user pivots the sheet 104 around the corner 216 as shown in FIG. 4B. Finally, the user places the edge 210 along the body of the fish 402 as shown in FIG. 4C. Similarly, the user may pivot the sheet 104 again until the full length of the fish is covered. Thereafter, the plurality of equidistant markings 202 may be used to determine the length of the fish.

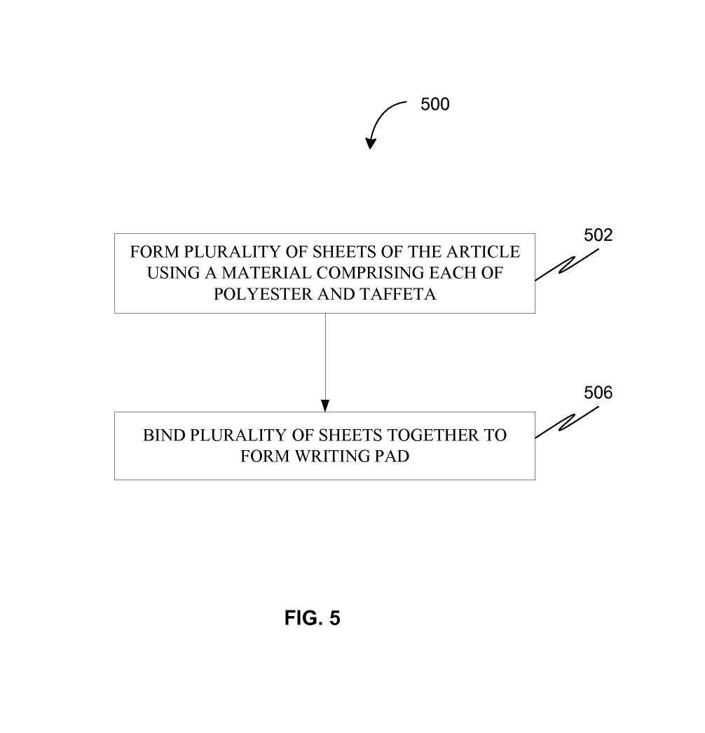

FIG. 5 is a flowchart illustration a method 500 for manufacturing an article capable of use in writing in a wet environment, in accordance with some embodiments. At 502, a plurality of sheets of the article is formed using a material comprising each of polyester and taffeta. The forming comprises weaving a thread made of polyester and taffeta to form the plurality of sheets.

Thereafter, at 504, the plurality of sheets are bound together to form a writing pad. For example, one or more edges of each of the plurality of sheets may be secured together. In addition to the form of a writing pad, the plurality of sheets may be bound together to form a diary, journal, or any other suitable compilation of writing sheets. The plurality of sheets may be removable and replaceable. The plurality of sheets may further be bound together to form a waterproof sketch pad for artists. As a waterproof sketch pad for artists, the present invention would be trademarked as “Plein Aquatic”.

Thereafter, on one or more sheets in the plurality of sheets, a plurality of equidistant markings are printed. The markings may be printed on the edges of the one or more sheets on one or both surfaces of the one or more sheets. The edges may then be used as a ruler. The printing is performed using an indelible ink. The ruler is a pivot ruler in the preferred embodiment but may be any suitable ruler.

The present invention may be branded with the name, logo, or slogan of any company.

It is intended that the disclosure and examples be considered as exemplary only, with a true scope and spirit of disclosed embodiments being indicated by the following claims.

We claim:

1. An article capable of use in writing, the article comprising at least one sheet configured for being written onto with a writing device, wherein a material of the at least one sheet comprises each of polyester and taffeta.

2. The article of claim 1, wherein the at least one sheet is water resistant.

3. The article of claim 1, wherein the at least one sheet is capable of being written onto in a wet environment.

4. The article of claim 1, wherein the wet environment comprises water.

5. The article of claim 1, wherein the at least one sheet comprises a plurality of sheets, wherein the plurality of sheets are secured together to form a writing pad.

6. The article of claim 5, wherein the plurality of sheets are secured together using a releasable glue.

7. The article of claim 1, wherein the at least one sheet is a fabric woven using a thread made of polyester and taffeta.

8. The article of claim 1, wherein the writing device is a pencil.

9. The article of claim 1, wherein a portion of at least one surface of the at least one sheet comprises printed information, wherein the printed information is indelible in a wet environment.

10. The article of claim 9, wherein the printed information corresponds to a guide.

11. The article of claim 10, wherein the guide is at least one of a fishing guide, a hunting guide, a survival guide, a navigation guide, an animal guide, a plant guide, a bird guide, an insect guide and an aquatic guide.

12. The article of claim 9, wherein the printed information comprises a plurality of equidistant markings along a plurality of peripheral regions on the at least one surface of the at least one sheet, wherein at least two peripheral regions of the plurality of peripheral regions overlap near a corner of the at least one sheet, wherein a plurality of edges of the at least one sheet corresponding to the plurality of peripheral regions are capable of being used as a ruler.

13. The article of claim 5, wherein a sheet of the at least one sheet forms a cover sheet of the writing pad, wherein a plurality of peripheral regions on an upper surface of the cover sheet comprises a plurality of equidistant markings, wherein at least two peripheral regions of the plurality of peripheral regions overlap near a corner of the cover sheet.

14. The article of claim 13, wherein the plurality of peripheral regions comprises four peripheral regions corresponding to the four edges of the cover sheet, wherein each of the four edges is capable of being used as a ruler.

15. The article of claim 1, wherein the at least one sheet comprises a grommet located at a peripheral region of the at least one sheet.

16. A method of manufacturing an article capable of use in writing in a wet environment, the method comprising:
a. forming a plurality of sheets of the article using a material comprising each of polyester and taffeta; and
b. binding the plurality of sheets together to form a writing pad.

17. The method of claim 16 further comprises printing a plurality of equidistant markings along a plurality of peripheral regions on at least one surface of a sheet of the plurality of sheets, wherein at least two peripheral regions of the plurality of peripheral regions overlap near a corner of the sheet, wherein a plurality of edges of the at least one sheet corresponding to the plurality of peripheral regions are capable of being used as a ruler.

18. The method of claim 17, wherein the printing is performed using an indelible ink.

19. The method of claim 16, wherein the forming comprises weaving a thread made of polyester and taffeta to form the plurality of sheets.

20. A writing pad capable of being used for writing in a wet environment, the writing pad comprising a plurality of sheets made of a material comprising each of polyester and taffeta, wherein at least one edge of each of the plurality of sheets is secured together.
